(19) United States
(12) Patent Application Publication
(10) Pub. No.: US 2001/0022419 A1
(43) Pub. Date: Sep. 20, 2001

(54) Work surface

(76) Inventor: Bruno Herren, Bern (CH)

Correspondence Address: Pauley Petersen Kinne & Fejer, Suite 365, 2800 W. Higgins Road, Hoffman Estates, IL, 60195, US

(21) Appl. No.: 09/757,063

(22) Filed: Jan. 9, 2001

(30) Foreign Application Priority Data
Feb. 16, 2000 (CH) 2000 0305/00

(51) Int. Cl. B23Q 3/00

(52) U.S. Cl. 269/289 R

(57) ABSTRACT

A work surface with a cutting plate of a plastic material and an approximately congruent plate of heat-resistant glass arranged at a distance from the cutting plate. The plates are, for example with a double sided adhesive tape, in connection regions, connected to one another at a distance so that between the plates there is an air gap. The work surface according to this invention combines the advantages of the known plastic chopping boards with those of known underlays of heat-resistant glass.

### BACKGROUND OF THE INVENTION

1. Field of the Invention

This invention relates to a work surface for a kitchen or household use. The work surface has a combination chopping board and underlay for pots.

2. Description of Related Art

Chopping boards of plastic material such as for example PMMA have been known for use in the household for many years and have been marketed by the applicant with great success. With respect to hygiene and mechanical resistance, chopping boards of wood and other materials have many advantages.

The manufacture is simple and inexpensive and there are no limits to coloring and shaping. The acrylic boards may be very simply and efficiently cleaned with hot water, with a series of cleaning and disinfection agents, or in the dishwasher. In contrast to wooden boards acrylic boards do not swell and after a long use their shape is maintained. One disadvantage of plastic chopping boards is their low heat stability. Acrylic chopping boards are not suitable as an underlay and/or resting surface for hot pots, pans and other cooking dishes, because on contact they immediately melt and are damaged beyond repair.

Plates of hardened glass, although being completely unsuitable as chopping boards and quickly and lastingly ruining cutting utensils, are however extremely heat resistant.

### SUMMARY OF THE INVENTION

It is one object of this invention to provide a device which may be used as a chopping board as well as a heat resistant underlay. Thus the device of this invention combines the advantages of chopping boards of known plastic materials and the advantages of underlays of hardened glass.

This object is achieved by a device according to the following description, each independent claim and the dependent claims.

### BRIEF DESCRIPTION OF THE DRAWINGS

The drawings show examples identifying the subject matter of this invention and the embodiments are explained in the subsequent description wherein:

FIG. 1 is an exploded top perspective view of one embodiment of a device according to this invention;

FIG. 2 is a cross section of a side region of a chopping board according to this invention; and

FIG. 3 is a top perspective view of another embodiment of a chopping board according to this invention, wherein adhesive tapes inside of a sandwich design are shown in dashed lines.

### DESCRIPTION OF PREFERRED EMBODIMENTS

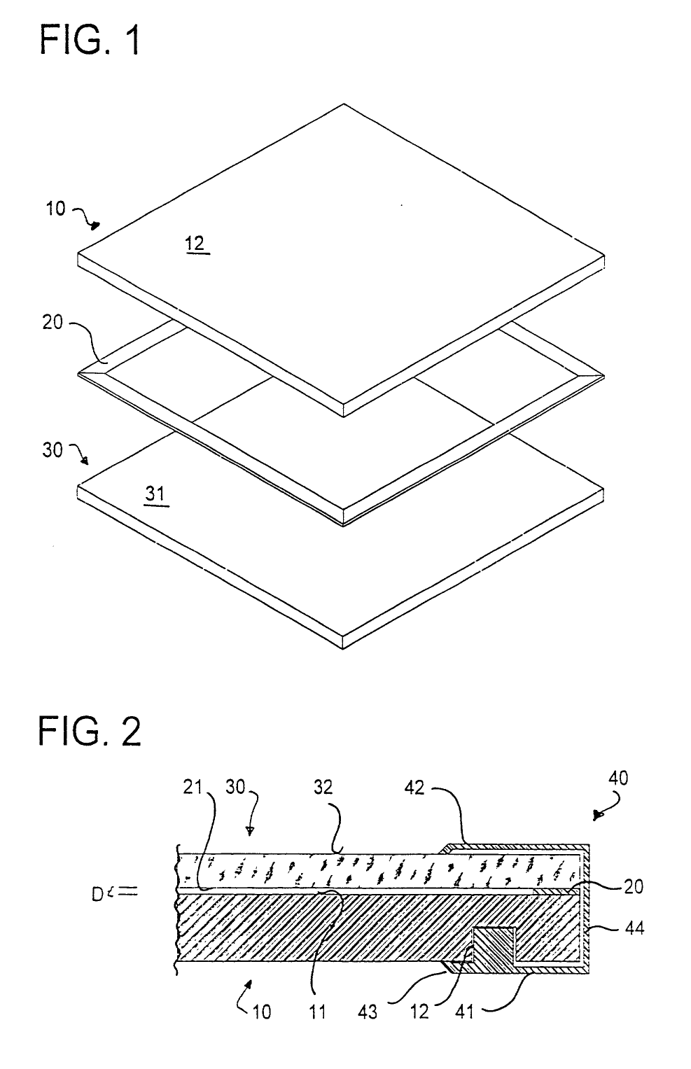

FIG. 1 shows a work surface according to this invention, respectively a chopping board/underlay combination which will also be described as a “combi-board”. The arrangement comprises an upper plate 10 which is manufactured of a known PMMA material or of SAN material. Below the plastic plate 10 lies a plate 30 of a heat-resistant glass which is shaped approximately congruent. Between the two plates 10, 30 along a peripheral region is arranged an adhesive tape 20, which is adhesive on both sides. The adhesive tape 20 is preferably transparent and elastic enough to compensate for large differences in the heat expansion of the two plates 10, 30. In a preferred embodiment, the adhesive tape 20 is of an acrylate polymer, such as is commercially available as an acrylic foam tape. Such adhesive tapes are according to European safety guidelines and are safe for humans and the environment. The adhesive tape 30 may be directly processed from the roll. Overlappings and projections of the adhesive tape 30 may be simply separated off with a knife. The pressing of both plates 10, 30 on one another is effected cold, wherein the plates 10, 30 beginning at one edge are slowly folded together to avoid air pockets between the adhesive surfaces of the tape 20 and the plates 10, 30.

In the constructed condition the sandwich of the upper plastic plate 10 and the lower glass plate 30 encloses an air-filled intermediate space 21 which acts in a heat-insulating manner. Because in the embodiment of this invention shown in FIG. 1 the adhesive tape 20 runs along the entire circumference of the two plates, the air-filled space is sealingly occluded with respect to the outer atmosphere. This not only maintains an insulating air cushion between the plates 10, 30 but it also prevents water or dirt from penetrating from the outside between the plates 10, 30. The connection of plastic plate 10 and glass plate 30 with an adhesive permits problem-free cleaning of the combi-board 1 in the dishwasher. In a preferred embodiment, acrylic plates 10 have a 2 to 3 mm thickness and are connected with an adhesive to hardened, heat-resistant, 2 to 3 mm thick glass plates 30, wherein corresponding to the height of the adhesive tape 20 there is an intermediate space 21 of 0.5 to 2 mm between the plates 10, 30.

FIG. 2 shows an edge region of a combi-board in cross section. Again, there can be a cutting plate 10 of plastic over which lies the glass plate 30. In an edge region the two plates 10, 30 are rigidly connected to one another by the adhesive tape 20. The adhesive tape 20 runs, similar to the embodiment shown in FIG. 1, in a peripheral region between the two plates 10, 30 so that outer edges of the plates 10, 30 and the adhesive tape 20 terminate in a flush manner. Between both plates 10, 30 there is an air gap 21 that corresponds to the thickness D of the adhesive tape 20. Because of the air gap 21 if a hot object is located on the glass plate 30, the inner side 31 of the glass plate 30, despite a relatively low heat conductibility of the glass plate 30, may under certain circumstances be heated to above the deformation and melting temperature of the plastic material of the plate 10. Since the plate of hardened glass 30 is less elastic the air gap 21 produced by the adhesive tape 20 is sufficient to prevent a direct contact between an inner side 31 of the glass plate 30 and an inner side 11 of the plastic plate 10. The air space 21 acts as an insulating air cushion between the two surfaces 11, 31.

In place of the adhesive tape 20 adhered to both sides, generally an adhesive agent applied in a locally limited manner, for example a line of a pasty adhesive mass of acrylate polymer or acrylate foam, may be used.

In one embodiment, as shown in FIG. 2, at least the corner regions of the combi-board have a corner protection 40. The corner protection 40 encompasses on both sides an edge region of the plates 10, 30 and is advantageously manufactured of an elastomer material. The corner protection 40 has in cross section a U-profile, wherein an upper limb 43 and a lower limb 42 encloses several millimeters up to a few centimeters of the edge region of the plates 10 and 30. As shown in FIG. 2, the corner protection 40 for fastening by way of a lug 41 at the upper limb 43 may engage within a corresponding recess 12 in the plate 10. The corner protection 40 advantageously bears sealingly against the inner region of the plates 10, 30 in order to prevent the penetration of contaminating fluids and particles. It may also in the whole region bear directly on the sandwich design and in this manner be releasable for cleaning purposes, clampingly fastened, or adhered to the plates 10, 30. The material of the corner protection 40 is advantageously selected so that it is non-slip and is easily cleaned. When required, the corner protection 40 may have additional slip-preventing naps or suction pads. The corner protection 40 prevents the particularly exposed corner regions of the glass plate 30 from being mechanically damaged. The underlying surface 32 of the glass plate 30 with sharp edges from the cutting operation are covered by the protecting limbs 42 and thus does not directly contact the other work surfaces and thus is scratched to a lesser extent.

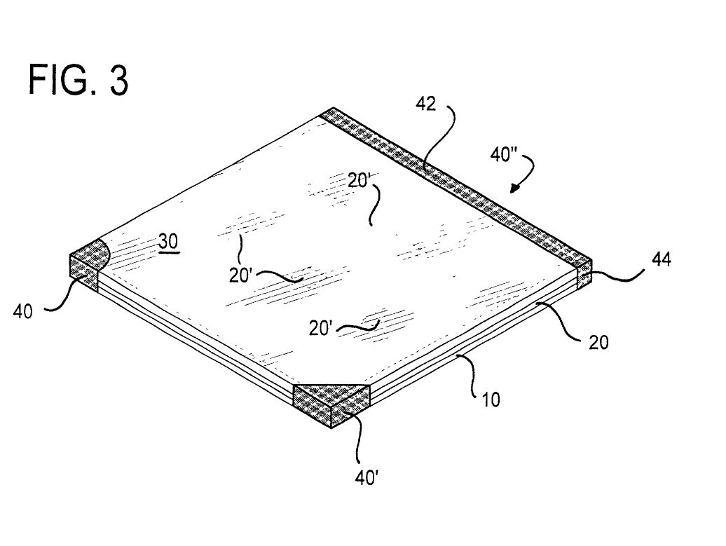

It is evident to a person skilled in the art that the corner protection 40 shown in FIG. 3 may also extend over an entire region of one or more longitudinal sides of the combi-board 1. The corner protection 40 can also be called an edge protection 40. The fastening of an edge protection 40 can be achieved by suspending one or several lugs 14 into one or several recesses or into a groove 12.

The combi-boards 1 according to this invention can function as an additional work surface in the kitchen. The combi-board 1 may be manufactured in a size which roughly corresponds to the size of usual cooking surfaces of electric and glass ceramic cookers. Thus the combi-board 1 with the heat-resistant glass side 32 can be placed on a hot glass ceramic surface to immediately make available a large working and cutting surface. This is particularly advantageous in small kitchens with little working area because the user need not wait until the cooking surface or individual cooking plates cool down.

With respect to manufacturing there are hardly any limits to the combi-boards 1 with respect to size and surface. From a practical standpoint, in an application in the kitchen the combi-boards 1 are used as additional work surfaces with a width and a depth adapted to the usual dimensions of cookers and work surfaces, which can be rectangular. If the width of the glass plate 30 is to exceed a range whereby a loading of the plate 30 causes a heavy bending, and the inner side 31 of the glass plate 30 contacts the inner side 11 of the plastic plate 10, then as indicated by the dashed lines in FIG. 3, additional regions in the inside of the combi-board 1 can have adhesive strips 20′ of a shorter or longer length. Thus it is ensured that in every region between the plates 10, 30 there is an insulating intermediate space 21.

Smaller combi-boards 1 which are used as transportable chopping boards and underlays may advantageously be formed rectangular, oval or round. The outer contour of the combi-boards 1 may have most varied shapes and is only limited by the technical expense associated with manufacturing and adhering complex contours.

The combi-boards 1 according to this invention have much greater room for play when it comes to design. If for example the inner side 11 of the plastic plate 10 has a pattern or picture then it is easily visible through the transparent glass plate 30 and is simultaneously protected. If so desired, then for example combination boards 1 can be created with an outer contour in the shape of vegetables, for example a tomato, while simultaneously a visible picture of a tomato is located on the inner side 11.

The plastic plate 10 can have circumferential grooves or lateral troughs for catching and collecting juice from an object when cut. In this case the plastic plate 10 is thicker than the previously described 2 to 3 mm.

In a lateral region the combi-board 1 may have one or more grips.

I claim:

1. A work surface (1) comprising: a chopping plate (10) of a plastic material and an approximately congruent plate (30) of a heat-resistant glass arranged at a distance to the chopping plate (10), the plates (10, 30) connected to each other in locally limited connection regions with at least one adhesive (20) and at a distance to one another to form an air gap (21) between the plates (10, 30).

2. A work surface according to claim 1, wherein the adhesive (20) comprises a plurality of adhesive tape sections adhered on one of both sides and a line of a pasty adhesive mass of an acrylate polymer.

3. A work surface according to claim 2, wherein one of the adhesive tape sections (20) and the line (20) has an elasticity which compensates for lateral expansion movements of the plates (10, 30) relative to one another from temperature differences in the plates (10, 30).

4. A work surface according to claim 1, wherein the plates (10) are manufactured of a PMMA material.

5. A work surface according to claim 1, wherein the plates (10, 30) are adhered to one another over an entire circumference to sealingly close an air gap (21) between the plates (10, 30) and the adhesive layer (20).

6. A work surface according to claim 5, wherein side surfaces of the plates (10, 30) and of the adhesive layer (20) lie approximately in one plane and terminate with one another in a flush manner.

7. A work surface according to claim 5, wherein the air gap between the plates (10, 30) is 0.5 to 2 mm.

8. A work surface according to claim 1, wherein within a corner region is attached an edge protection device (40).

9. A work surface according to claim 8, wherein the edge protection device (40) is one of manufactured of a slip-resistant plastic material and has slip-preventing naps or suction pads.

10. A work surface according to claim 1, wherein the work surface is a temporary covering for a cooking surface of a cooker.

11. A work surface according to claim 1, wherein the air gap between the plates (10, 30) is 0.5 to 2 mm.
